(19) United States
(12) Patent Application Publication
(10) Pub. No.: US 2003/0206140 A1
(43) Pub. Date: Nov. 6, 2003

(54) Integrated multipath limiting ground based antenna

(76) Inventors: D. Bryce Thornberg, Hurricane, UT (US); Dean S. Thornberg, Salt Lake City, UT (US)

Correspondence Address: K. S. Cornaby, Jones, Waldo, Holbrook & McDonough, Suite 1500, 170 South Main Street, Salt Lake City, UT, 84101, US

(21) Appl. No.: 10/430,959

(22) Filed: May 5, 2003

Related U.S. Application Data
(60) Provisional application No. 60/378,700, filed on May 6, 2002.

(51) Int. Cl. H01Q 21/26; H01Q 1/12

(52) U.S. Cl. 343/798; 343/890

(57) ABSTRACT

An integrated dual antenna system for Global Positioning System (GPS), Local Area Augmentation System (LAAS), ground based subsystem surface mounted (pole/tower/platform/other) and coaxially stacked (over and under). The dual antenna and receiver system is specifically designed and tuned to receive only the direct GPS satellite ranging signals while highly rejecting the ground multipath (indirect) signals. The upper antenna is a Right Hand Circularly Polarized (RHCP) omni-directional High Zenith Antenna (HZA) with dual obstruction lights and dual air terminals. The lower antenna is an electrically long vertically polarized omni-directional linear phased array having a very sharp horizon cut off and is a Multipath Limiting Antenna (MLA). When the two antennas (MLA and HZA) are mounted together they become the Integrated Multipath Limiting Antenna (IMLA). Interoperability is assured by high RF isolation between antennas. Both antennas are broad-band and have precisely controlled vertical and horizontal radiation patterns. Together the radiation patterns cover the complete upper hemisphere where satellites are visible.

This application claims the benefit of U.S. Provisional Application No. 60/378,700 filed May 6, 2002.

### BACKGROUND OF THE INVENTION

The Local Area Augmentation System (LAAS) is in the late stages of being developed to support the differential Global Navigational Satellite System (GNSS) based aircraft precision approaches and landings. Applications other than precision approach and landing may also be supported. The LAAS, when implemented using the Global Positioning System (GPS) as the source of satellite navigation signals, is known as the GPS/LAAS and is shown in FIG. A. It consists of three primary subsystems:

A) The satellite subsystem, which produces ranging signals. This standard explicitly addresses the use of GPS and SBAS (satellite based augmentation system). Provision has been made for the use of other satellite systems such as the Russian GLONASS.

B) The ground subsystem, which provides a VHF data broadcast (VDB) containing differential corrections and other pertinent information. Ground-based ranging signals may also be provided by airport pseudolites (APL's) to enhance system availability.

C) The airborne subsystem, which encompasses the use of aircraft equipment, receives and processes the LAAS/GPS signal in space in order to compute and output a position solution, deviations relative to a desired reference path and appropriate annunciation.

First, the GPS satellites provide both the airborne subsystem and a ground-based subsystem with ranging signals. Second, the ground subsystem produces ground-monitored differential corrections and integrity-related information as well as data including the definition of the final approach path, a geometric path in space to which the aircraft on approach will navigate. These data are transmitted on a VHF data broadcast (VDB) to the airborne subsystem. The content and format of the data provided via the VDB are defined in RTCA, GNSS-Based Precision Approach Local Area Augmentation System (LAAS) Signal-in-Space Interface Control Document (ICD). Third, ground based APL's may be used to provide additional ground-monitored ranging signals to the airborne system.

The airborne subsystem uses the GPS/LAAS SIS (signal in space) to calculate a differentially-corrected position estimate and generates deviation signals with respect to the final approach path. The airborne subsystem also provides appropriate annunciations of system performance (e.g alerts). A position-velocity-time (PVT) output with integrity is also provided and may support other applications.

The airborne subsystem outputs are formatted as appropriate to interface with other aircraft equipment used to support the particular operation. For example, “ILS lookalike” deviation outputs are provided to aircraft displays and/or navigation systems. The airborne subsystem also provides appropriate annunciations of system performance (e.g alerts).

A plurality of IMLA's (FIG. 1) described herein, significantly reduce the inherent multipath corruption in ground based GPS reference stations. This multipath reduction ability allows the LAAS to support CAT I/II/III type approach and landings with the accuracy and integrity required while only depending on the GPS L1 C/A carrier smoothed code signal.

[image]

FIG. A, Typical LAAS System

Published research on methods to reduce the amount of ground multipath by Ohio University have helped optimize the method used to attenuate the LAAS GPS multipath to a minimum. As shown in FIG. B, Ohio University's idea of dividing the hemispherical coverage into 2 separate antenna beams has allowed an antenna design which can provide significantly better multipath performance than a single beam approach. This concept was originally published in 1994 by Ohio University.

[image]

FIG. B, LAAS Ground Sub-System Schematic Layout

This type of dual beam antenna system divides the required hemispherical coverage volume into two or more pieces in order to optimize the antenna's performance. The main discovery that Ohio University made when proposing this dual beam antenna approach was that the High Zenith Antenna could be made to fill in the natural “Null” that occurs directly above a collinear array of vertically polarized radiating elements.

The dominant error source in differential global positioning systems (DGPS) applications is multipath. Multipath occurs when a signal arrives at its destination via multiple paths resulting from reflections and/or diffractions. Multipath is troublesome to navigation ranging systems when the signal amplitude of the multipath is strong relative to the direct signal. In addition, since reflections and diffractions involve larger path lengths than the direct signal, they incur a time delay, which can affect GPS code or carrier measurements. This time delay is a significant problem for GPS since it performs time-based ranging measurements.

Ground multipath from satellite transmissions is the largest error source for the LAAS because of its close proximity to the ground and its nearly static geometry.

The invention described herein deals mainly with antenna techniques to reduce ground multipath. By shaping the antenna gain, phase and group delay patterns appropriately, the amount of multipath, phase and group delay errors that enter the receiver front end can be significantly reduced. A common way to characterize an antenna's multipath rejection capability is in terms of a power ratio referred to as the desired-to-undesired (D/U) ratio. The D/U ratio is also known as direct-to-indirect ratio, down-to-up ratio and a variety of other names. The DIU ratio is calculated for a given elevation angle in order to assess the ground multipath rejection capability of an antenna and thus tells how many dB of multipath can be rejected after the radio frequency (RF) stages of a transmitter and before the RF stages of a receiver. DIU is shown graphically in FIG. C.

[image]

FIG. C: Graphical Illustration of the D/U Ratio

### SUMMARY OF THE INVENTION

The above stated system requirements led to the development of a dual beam antenna system which significantly reduces multipath errors before they enter the receiver front end.

Another objective of the invention was to create an antenna which provides full hemispherical coverage while maintaining excellent multipath performance as well as excellent gain and phase stability with minimal group delay over the operational frequency band. The invention consists of the integration of a High Zenith Antenna (HZA) and a Multipath Limiting Antenna (MLA) which together form the Integrated Multipath Limiting Antenna (IMLA). The HZA receives GPS information from high elevation satellites (30 degrees through 90 degrees) at all azimuths and the MLA receives GPS information from low elevation satellites (2 degrees through 35 degrees) at all azimuths.

The invention also provides complete environmental protection for stable operation in an airport environment for extended periods of operation.

### BRIEF DESCRIPTION OF THE DRAWINGS

In the drawings:

FIG. 1 is a diagrammatic side elevational view of a 16 element MLA configured into a Integrated Multipath Limiting Antenna (IMLA). This drawing includes the High Zenith Antenna (HZA), junction box, dual obstruction lights, dual lighting protectors and pipe mounting adaptor. The Figure includes:

Item 17—outer radome fiberglass

Item 18—spacer, sponge rubber

Item 19—inner radome fiberglass

Item 20—array multi element (14 or 16 element typical)

Item 21—high zenith antenna (HZA)

Item 22—pipe adapter for antenna mounting

Item 25—RF power distribution assembly (PDA) microstrip

Item 44—low noise amplifier and filter

FIG. 2 is a diagrammatic side elevational view of a 20 element MLA configured for Wideband Airport Pseudolite (WBAPL) transmissions with dual obstruction lights, air terminal and pipe mounting adaptor. The WBAPL may be deployed with or without an HZA. The Figure includes:

Item 17—outer radome fiberglass

Item 18—spacer, sponge rubber

Item 19—inner radome fiberglass

Item 22—pipe adapter for antenna mounting

Item 23—array pseudolite multi element (20 element typical)

Item 24—obstruction light/air terminal adapter

Item 25—RF power distribution assembly (PDA) microstrip

FIG. 3 is a fragmentary internal schematic side elevational view of the amplitude and phase RF feed distribution network for both MLA and WBAPL. The Figure includes:

Item 25—RF power distribution assembly (PDA) microstrip

Item 26—RF power/phase coax transmission line system (14 to 20 element typical)

FIG. 4 is a fragmentary diagrammatic side elevational view of the radiating elements (cylindrical dipoles and upper/lower RF chokes) and RF feed distribution network for both the MLA & WBAPL. The Figure includes:

Item 20—array multi element (14 or 16 element typical)

Item 23—array pseudolite multi element (20 element typical)

Item 25—RF power distribution assembly (PDA) microstrip

FIG. 5 is an enlarged fragmentary sectional view of symmetrically fed metallic radiating cylindrical dipoles and a RF decoupling upper cylindrical choke, all positioned around the metallic center support tube. The Figure includes:

Item 1—RF power/phase coax transmission line system

Item 2—central metal support tube

Item 3—signal source

Item 4—coax feed thru

Item 5—feed thru outer end

Item 6—RF feed wire

Item 7—upper dipole half

Item 8—conductive bulkhead

Item 9—upper dipole half cavity

Item 10—lower dipole half cavity

Item 11—lower dipole bulkhead

Item 12—array end RF choke cavity

Item 13—lower dipole half

Item 17—outer radome fiberglass

Item 18—spacer, sponge rubber

Item 19—inner radome fiberglass

FIG. 5a is an enlarged fragmentary sectional view of a cylindrical dipole symmetric feed using wires and coax feed thru center tube wall. The Figure includes:

Item 1—RF power/phase coax transmission line system

Item 2—central metal support tube

Item 6—RF feed wire

Item 7—upper dipole half

Item 9—upper dipole half cavity

FIG. 5b is an enlarged fragmentary sectional view of a cylindrical dipole symmetric feed using conductive cross-bars and couplers (in lieu of wires) and coax feeds thru center tube wall. The Figure includes:

Item 1—RF power/phase coax transmission line system

Item 2—central metal support tube

Item 4—coax feed thru

Item 7—upper dipole half

Item 13—lower dipole half

Item 15—feed coupler

Item 16—symmetric feed cross-bar

FIG. 5c is an enlarged fragmentary sectional view of non-symmetric feed using inductance reducer and coax feeds thru center tube wall. The Figure includes:

Item 1—RF power/phase coax transmission line system

Item 2—central metal support tube

Item 7—upper dipole half

Item 14—non-symmetric feed inductance reducer

Item 15—feed coupler

FIG. 5d is an enlarged fragmentary sectional view of non-symmetric feed using single cross-bar and coupler, and coax feed thru center tube wall. The Figure includes:

Item 1—RF power/phase coax transmission line system

Item 2—central metal support tube

Item 7—upper dipole half

Item 15—feed coupler

Item 16—symmetric feed cross-bar

FIG. 6 is a schematic view of the High Zenith Antenna (HZA) forming part of the IMLA antenna system showing the obstruction lights, air terminals and junction box. The Figure includes:

Item 28—radome HZA fiberglass

Item 30—hub center support

Item 31—90 degree power hybrid combiner

Item 32—cross-V-dipole

Item 33—ferrite isolator

Item 34—lower counterpoise (beam forming) and aluminum mounting plate

Item 35—concave reflector and upper counterpoise (beam forming)

Item 36—RF choke HZA large diameter 360 degrees

Item 37—microwave absorbing material (beam forming)

Item 38—air terminal 2 places

Item 39—obstruction light 2 places

Item 40—junction box with cover

Item 41—anti-bird spike

Item 42—cover junction box, not shown, part of lanyard

Item 43—low noise amplifier

FIG. 7 shows measured elevation radiation gain patterns in dBi for: 14 element, 16 element and 20 element multipath limiting antennas (MLA's) where 0 degrees is the horizon, +90 degrees is straight up and −90 degrees is straight down into the ground;

FIG. 8 shows measured elevation radiation patterns for desired to undesired (direct to indirect) ratios in dB from 0 to 90 degrees for: 14 element, 16 element and 20 element MLA's where 0 degrees is the horizon and +90 degrees is straight up away from the ground;

FIG. 9 is same as FIG. 7 zoomed to an elevation angle span from −35 to 35 degrees;

FIG. 10 is the same as FIG. 8 zoomed to an elevation angle span from −35 to 35 degrees;

FIG. 11 is the same as FIG. 7 zoomed to an elevation angle span from −15 to 15 degrees;

FIG. 12 is the same as FIG. 8 zoomed to an elevation angle span from 0 to 15 degrees;

FIG. 13 shows measured MLA azimuth radiation patterns in dBi from 0 to 360 degrees at four different elevation angles;

FIG. 14 shows measured HZA right hand circular polarized (RHCP) vertical radiation pattern in dbic from 0 to 360 degrees; wherein 0 and 360 degrees are straight down, 90 and 270 degrees are on the horizon and 180 degrees is straight up;

FIG. 15 shows measured HZA RHCP azimuth radiation patterns in dBic from 0 to 360 degrees at 4 different elevation angles; and

FIG. 16 shows how the HZA and MLA antenna radiation patterns superimpose to provide complete above the horizon coverage.

### DETAILED DESCRIPTION OF THE PREFERRED EMBODIMENTS

I. Multipath Limiting Antenna (MLA)

FIG. 1 illustrates an integrated multipath-limiting antenna (IMLA) which includes: MLA array multi element 20, high zenith antenna (HZA) 21 and a pipe adaptor for antenna mounting 22. The MLA has a coaxially configured outer radome fiberglass 17 and inner radome fiberglass 19 for greater strength, durability, longitudinal stiffness and a means to heat (de-ice) the antenna when required. The High Zenith Antenna (HZA) includes air terminals, dual obstruction lights and a junction box.

For detailed theory of operation of the MLA refer to FIG. 5, where central metal support tube 2 contains a RF power/phase coax transmission line system 1 which comes from a signal source (receiver or transmitter or both). The RF power/phase coax transmission line system 1 goes thru the wall of the central metal support tube 2, via coax feed thru 4, 1 & 2 are fastened together securely locked and soldered so that no RF energy is fed into the inside of central metal support tube 2. The connection at feed thru outer end 5 thru RF feed wire 6 is to a metallic cylindrical dipole approximately ¼ wavelength long. Cylindrical upper dipole half 7 is conductively coupled (soldered) to central metal support tube 2 by a conductive bulkhead 8. The current on the outside of upper dipole half 7 can flow without interruption until it gets to the central metal support tube 2. The current flow along upper dipole half 7 is then radiated omni-directionally in azimuth since no metallic items are present to alter the non-directional radiation.

The other region experiencing the voltage existent between the center conductor of RF power/phase coax transmission line system 1 and the shield of RF power/phase coax transmission line system 1 is the lower dipole half cavity 10 closed and electrically connected to central metal support tube 2 at the upper end by the lower dipole bulkhead 11.

It is well known from transmission line theory that the input impedance of a shorted quarter wave line is Z=+j [symbol] ₀tanθ. In this case θ is essentially 90 degrees. Therefore, the input impedance to lower dipole half cavity 10 is either very high or infinite. The lower dipole half cavity 10 has little effect on the impedance presented to RF power/phase coax transmission line system 1. However, the current flowing along the outside of upper dipole half 7 is experiencing radiation resistance.

Mounted on central metal support tube 2 above upper dipole half 7 is a array end RF choke cavity 12 with the same dimensions as upper dipole half 7 and upper dipole half cavity 9. When the current flowing along upper dipole half 7 gets to the conductive bulkhead 8, it tries to flow into array end RF choke cavity 12 which also has high input impedance. Since this impedance is very high, it essentially acts as an open circuit or end of line. The MLA linear (collinear) array includes a single or multiplicity of RF chokes at each end of central metal support tube 2 which effectively eliminates unwanted RF current flow along central metal support tube 2.

Some of the voltage on the center conductor of RF power/phase coax transmission line system 1 is impressed on the lower dipole bulkhead 11. The current produced by this voltage runs along lower dipole half 13 experiencing radiation resistance for essentially a quarter wavelength. The input impedance to lower dipole half cavity 10 is very high so very little energy continues down central metal support tube 2. The lower dipole half 13 acts like a quarter wave radiator. The current flowing along lower dipole half 13 is of opposite phase to that flowing along upper dipole half 7. Since it is flowing in the opposite direction, its radiation is in phase with the radiation from upper dipole half 7. These two excited quarter wavelength radiators, FIG. 5 items upper dipole half 7 and lower dipole half 13, then form something equivalent to a half wavelength cylindrical dipole. The diameter of this cylindrical dipole is made electrically large to allow for significant operating bandwidth. This provides excellent group delay response from the array multi element 20.

The number of half wavelength dipoles used in one MLA array can be from 2 to n depending on the desired gain and pattern slope requirements. The current MLA arrays contain: fourteen, sixteen and twenty half wavelength dipoles.

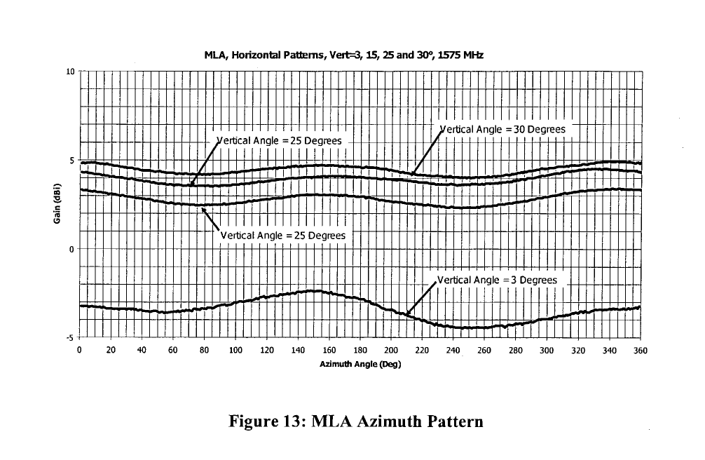

FIGS. 5, 5a and 5b describe symmetrical feeds where the driven element (cylindrical dipole half/cavity) of each half wavelength dipole is fed at four equally spaced points around its open end circumference. Symmetrical feeds improve the radiated azimuth pattern circularity over the non-symmetric feed methods (see FIG. 13). Symmetric feeds shown in FIGS. 5 and 5a are referred to as RF feed wires 6. Those shown in FIG. 5b are referred to as symmetric feed cross-bar 16 & feed coupler 15 symmetric feeds.

Non-symmetric feeds shown in FIGS. 5c and 5d are used in arrays having lesser circularity requirements and are less costly to build, 5c is referred to as non-symmetric feed inductance reducer 14 and feed coupler 15, 5d is referred to as symmetric feed cross-bar 16 and feed coupler 15.

Inductance reducer FIG. 5c is used for a low cost non-symmetrical feed. The circumference of the open end of upper dipole half 7 is an appreciable portion of a wavelength. In the case of upper dipole half 7, in order to reduce this inductance, a non-symmetric feed inductance reducer 14 of metallic plate is connected to a short feed coupler 15 shown in FIG. 5c. The non-symmetric feed inductance reducer 14 allows for a some what shortened length of feed coupler 15 in feeding the circumference at the bottom of upper dipole half 7.

Spiral feed (not shown in the figures) for non-symmetrical feeds are also used to improve azimuth pattern circularity. In some cases where non-symmetrical feeds are used, each feed is rotated a number of degrees, in azimuth, from the one below it. This results in a total radiation pattern that is more circular than from a non-spiraled feed system, however, symmetrical feeds provide the best circularity.

In FIG. 5 outer radome fiberglass 17, spacer, sponge rubber 18 and inner radome fiberglass 19 make up the multi-purpose antenna support structure and provide environmental protection.

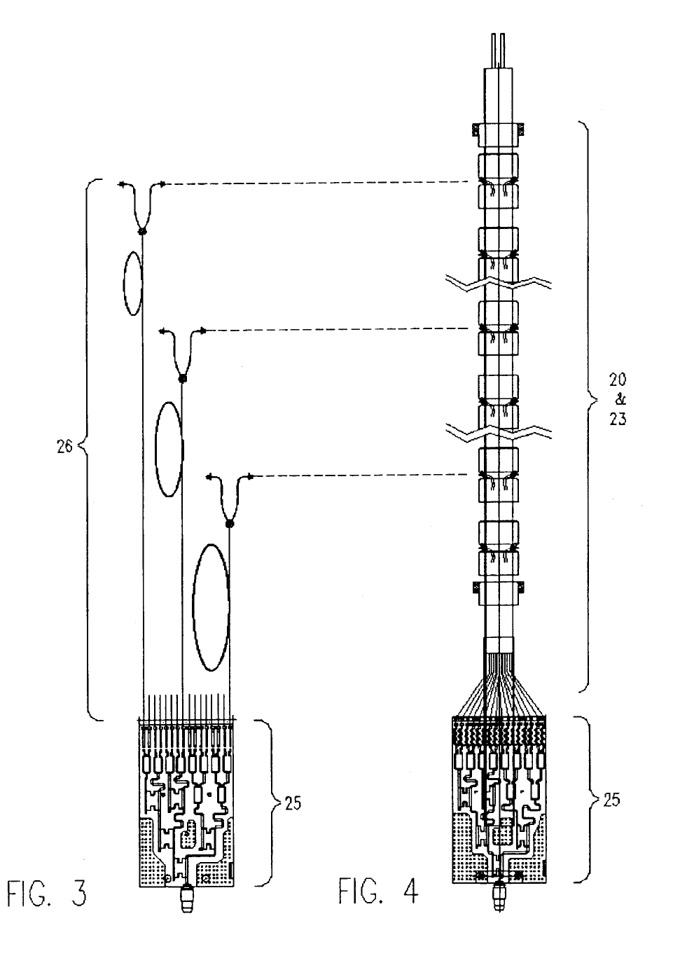

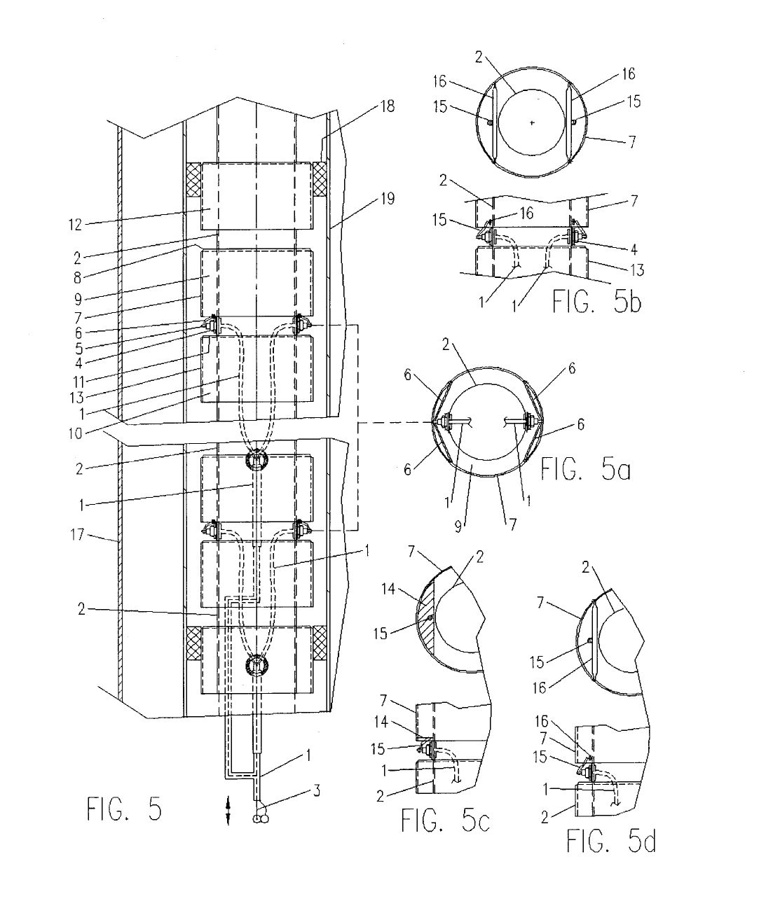

MLA vertical radiation pattern. See FIG. 1 (array multi element 20 and RF power distribution assembly (PDA) microstrip 25), FIG. 3 (RF power distribution assembly (PDA) microstrip 25 and RF power/phase coax transmission line system 26) and FIG. 4 (RF power distribution assembly (PDA) microstrip 25, array multi element 20 and array pseudolite multi element 23). Vertical pattern shaping is critically important in achieving satisfactory performance for LAAS, especially in the vicinity of the horizon. To achieve the required multipath rejection each half wave dipole (driven element) in the array FIG. 1 (array multi element 20) must receive RF at the exact magnitude (amplitude) and at the exact time (phase) relative to all the other active elements in the array. The phase fed to each element must also be very constant as a function of the antenna bandwidth to minimize group delay variation which causes errors in GPS ranging.

To determine these critical RF amplitudes and phases a highly sophisticated/customized pattern synthesis computer program was developed which provides independent control of each lobe and null depth in the vertical radiation pattern. FIG. 1 (RF power distribution assembly (PDA) microstrip 25) is a printed wiring board which divides/sums the RF energy in the synthesized, correct manner to/from each driven element. FIG. 3 (RF power/phase coax transmission line system 26) is the coaxial feed harness which aids in the formation of the correct amplitude/phase distribution across the array aperture. To the maximum extent possible these coax lengths, FIG. 3 (RF power/phase coax transmission line system 26), provide the same electrical delay which is fed to each dipole which helps provide larger bandwidth, less temperature susceptibility and more constant group delay as a function of frequency.

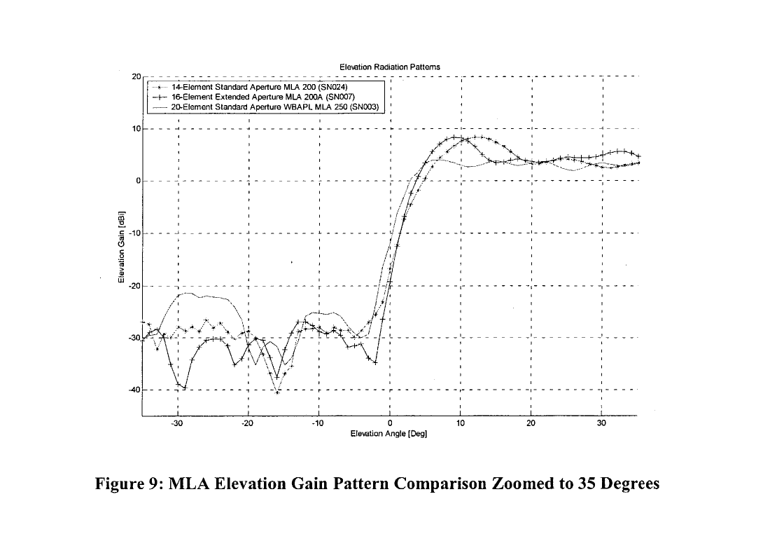

As the number of active elements in the array is increased, greater vertical pattern beam control is obtained. Spacing between active elements (see FIG. 4 array multi element 20 and array pseudolite multi element 23) is also an important factor which can be varied to obtain optimum pattern beam shape. Measured antenna patterns (detailing actual MLA array performance) are shown in FIGS. 7, 8, 9, 1 0, 11 and 12.

II. Wideband Airport Pseudolite Multipath Limiting Antenna (WBAPL)

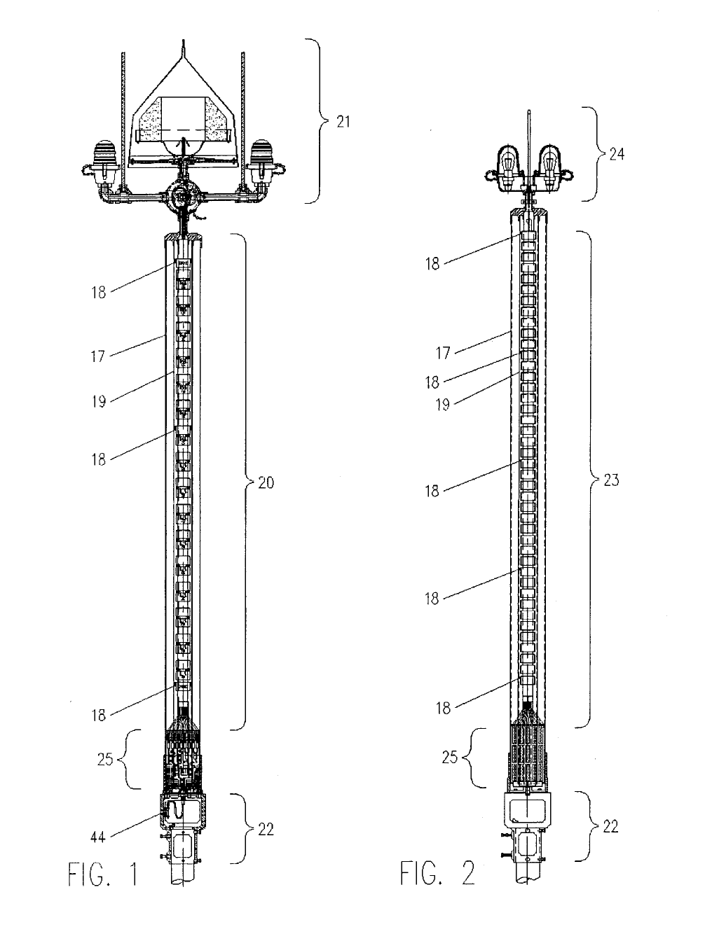

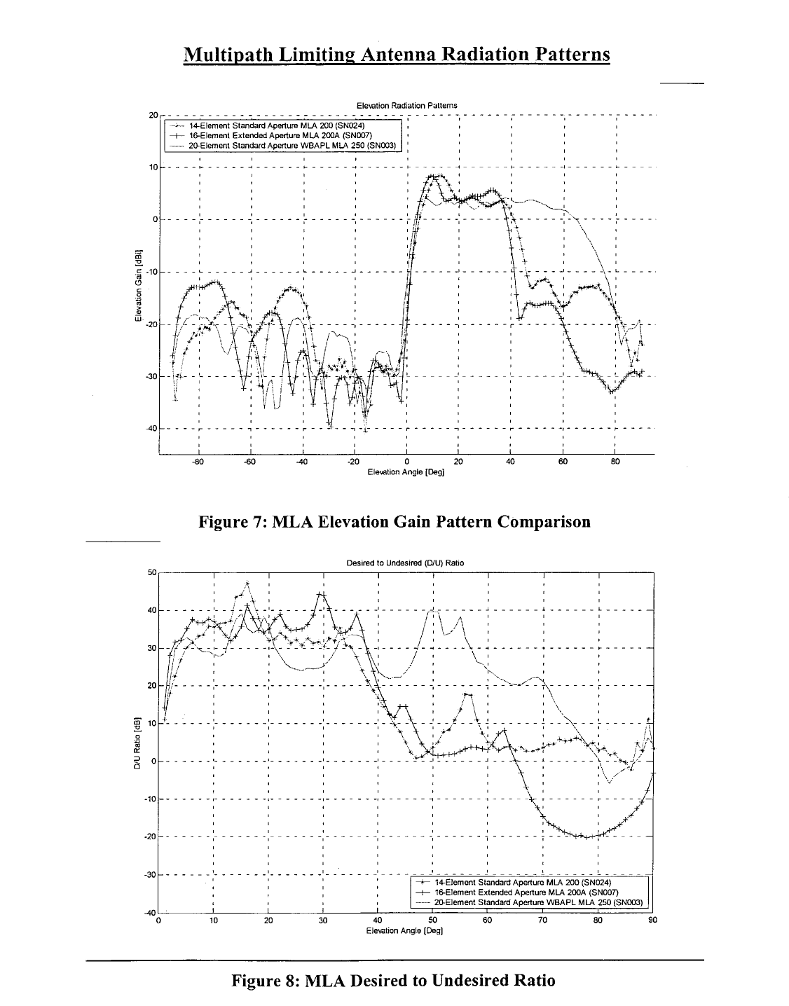

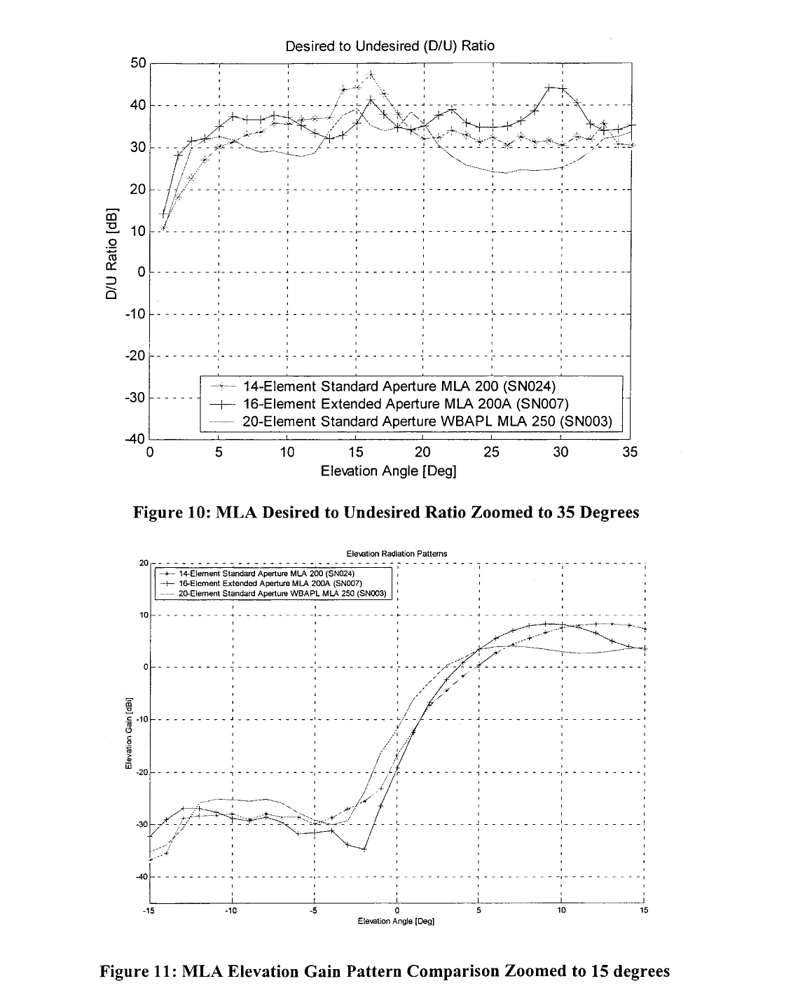

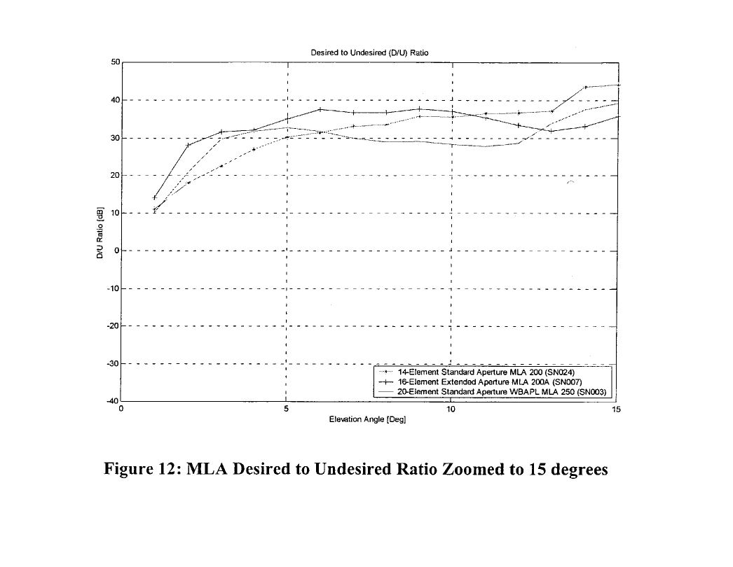

See FIG. 2 WBAPL vertical pattern, FIG. 2 (array pseudolite multi element 23 and RF power distribution assembly (PDA) microstrip 25), FIG. 3 (RF power distribution assembly (PDA) microstrip 25 and RF power/phase coax transmission line system 26) and FIG. 4 (array multi element 20, array pseudolite multi element 23 and RF power distribution assembly (PDA) microstrip 25). The theory and techniques used and described in the MLA description are the same for that of WBAPL. The WBAPL, however, has equal to or greater multipath rejection capabilities, greater gain vs. angle control and greater vertical angle coverage than the MLA. The MLA WBAPL is a 20 active element array FIG. 2 (array pseudolite multi element 23); it may be deployed with or without the high zenith antenna 21. It may be deployed with only obstruction light/air terminal adapter 24 if desired. Measured antenna patterns (detailing actual WBAPL array performance) are shown in FIGS. 7, 8, 9, 10, 11 and 12.

III. High Zenith Antenna (HZA)

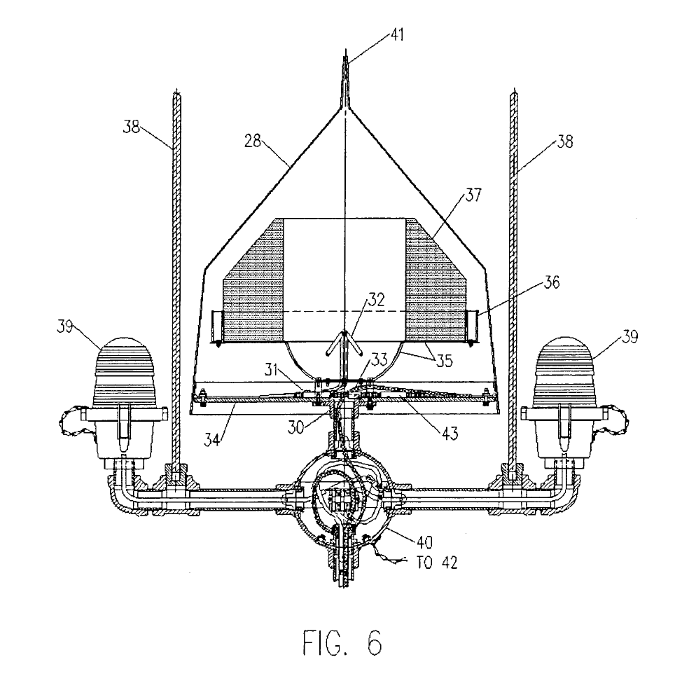

See FIG. 6. The HZA is designed to receive satellite signals from +30 degrees to +90 degrees in elevation angle above the horizon. Thus when integrated with the MLA, complete hemispherical coverage is obtained. The greater the number of satellites received, the greater the system accuracy, availability and integrity. The HZA radiation pattern must be commensurate with the performance of the MLA, see FIG. 16.

The HZA is preferably enclosed in a radome HZA fiberglass 28 with associated hub center support 30 and lower counterpoise (beam forming) and aluminum mounting plate 34 for mounting and environmental protection. The HZA has an integral low noise amplifier 43 used to amplify low-level GPS signals and a 90 degree power hybrid combiner 31 for proper connection to the cross-V-dipole 32 which functions to combine the cross-V-dipole 32 in the RHCP sense. The symmetrical cross-V-dipole radiating element helps maintain close to equal vertically and horizontally polarized RHCP orthogonal components. The cross-V-dipole exhibits a very stable and accurate phase center as well as a minimal group delay due to its electrical symmetry and large operational bandwidth. This results in a significant improvement of the antenna's ellipticity ratio over the usable service volume.

A ferrite isolator 33 is also utilized at the antenna output which absorbs any possible reflections which may occur in the RF interconnection between the antenna and the GPS receiver. Impedance mismatches and/or cable reflections may result in standing waves in the interconnecting cables which can look like multipath to the GPS receiver.

An L1 band pass filter (not shown) can be installed before the LNA to reduce out of band signals which may cause interference to the GPS receiver. The MLA is also equipped with a low noise amplifier and filter, FIG. 1 item 44 which are located below the MLA in the pipe adapter for antenna mounting 22 which is used to adapt the IMLA to a 4″ O.D. pipe for mounting purposes.

The HZA implements a combination of antenna technologies including:

A) A flat, conductive, reflecting lower counterpoise (beam forming) and aluminum mounting plate 34 oriented orthogonal to the vertical axis of the antenna.

B) A shaped concave reflector and upper counterpoise 35 electrically connected to the lower counterpoise 34 which electrically and mechanically connects to the cross-V-dipole 32.

C) A 360 degree oriented, quarter wave, RF choke 36 which aids in the suppression of the surface wave which exists on the surface of the microwave absorbing material 37.

D) A beam forming shaped piece of RF absorbing material 37 with a precisely known and controlled carbon fill factor. This “Shaped Absorber” provides controlled positive angle radiation through use of its shaped inside contour as well as a shaped outside contour to control the broadside and negative angle portions of the radiation pattern.

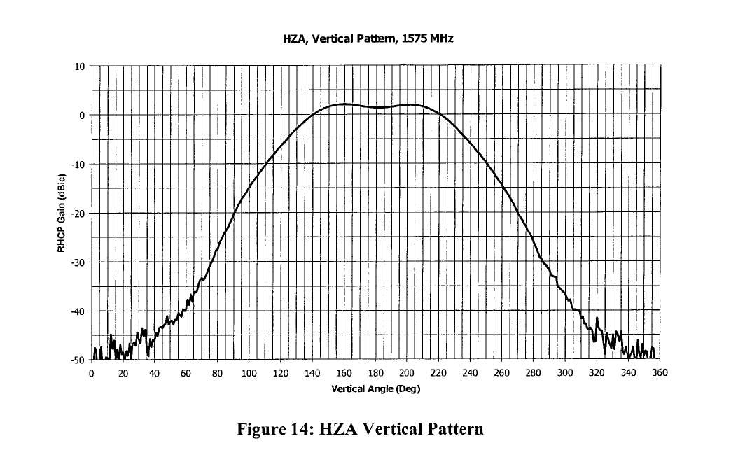

See FIGS. 14 and 16. The pattern above the horizon is shaped to yield a maximum pattern variation of approximately 5 dB between the vertical angles of +30 degrees and +90 degrees. The main beam peak gain is approximately 2 dBic.

The vertical phase pattern of the HZA is nearly constant and does not change more than 2 cm over the HZA coverage volume.

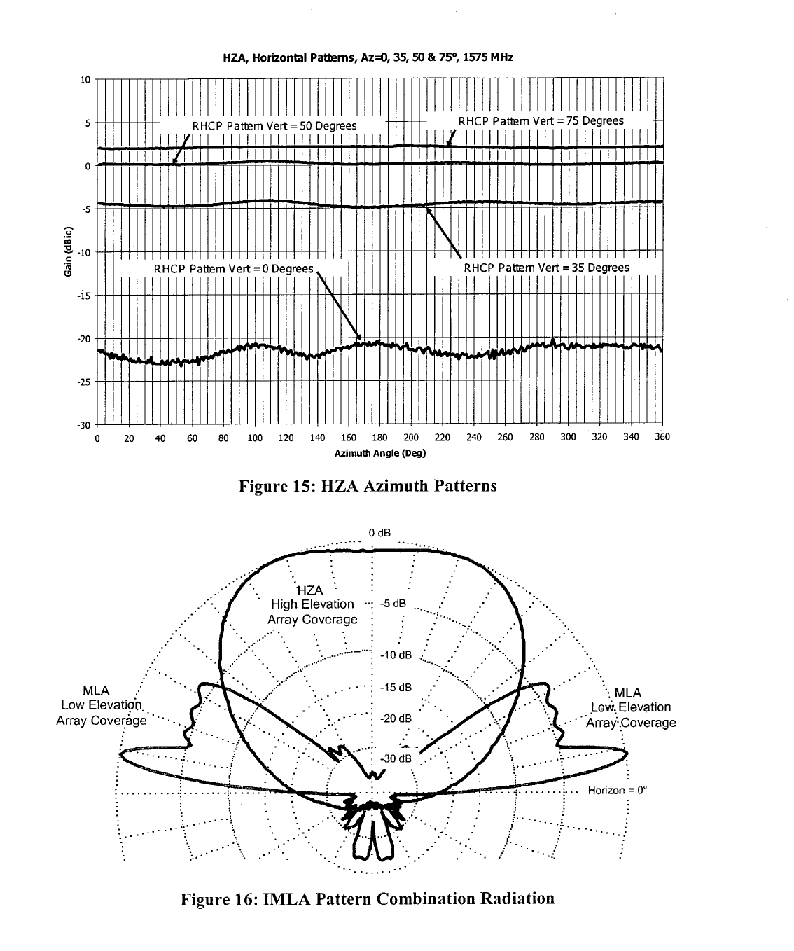

The horizontal azimuth patterns of the HZA are shown in FIG. 15. The phase variation in the horizontal plane is circular and exhibits the expected 360 degree linearly progressing phase shift for a RHCP antenna.

See FIG. 6 items 38 are air terminals 2 places, 39 are obstruction lights 2 places, 40 is a junction box with cover for cable connections. (Cover junction box 42 and lanyards not shown.)

The above descriptions are those of preferred embodiments of the invention. Various alterations and changes can be made without departing from the spirit and broader aspects of the invention as defined in the appended claims.

The embodiments of the invention in which an exclusive property or privilege is claimed are defined as follows:

What is claimed:

1. An integrated dual antenna system having broadband elements and nearly constant group delay, comprising (1) an MLA antenna having large diameter cylindrical dipole elements and an almost equal drive phase to each active dipole; and (2) an HZA antenna having a broad-band cross-V-dipole, so that together the dipole element configurations provide a large bandwidth with radiation characteristics that are not sensitive as a function of element geometry.

2. An antenna system as set forth in claim 1, wherein the precise location of the MLA with respect to the HZA is determined by establishing the precise survey of the HZA phase center location such that only a vertical offset need be used to determine the surveyed phase center of the MLA, and wherein the phase center of the MLA varies as a function of said antenna's vertical angle which positioning makes possible the precise three-dimensional determinations of both the antenna locations of an HZA and MLA reference point required to program LAAS ground station receiver control relative to satellite positions.

3. An antenna as set forth in claim 1, providing continuous phase variation monitoring of the MLA with respect to the precisely known location of the HZA phase center, having a very low failure rate due to simple passive design and use of close stable components, including special radome, cross-V-dipole, double counterpoise, reflector bowl, choke and microwave absorbing beam-forming material.

4. An antenna system as set forth in claim 1, providing azimuth symmetry of the HZA and MLA antennas, which in turn provide constant amplitude, phase and group delay over the horizontal patterns of each antenna, and wherein amplitude, phase and group delay corrections as a function of the azimuth patterns are not required, but are made possible by symmetrical feeds and flat, non-angled components in the azimuth plane, including upper dipole half (7), conductive bulkhead (8), lower dipole bulkhead (11), lower dipole half (13), lower counterpoise beam forming (34), and concave reflector/counterpoise (35).

5. An antenna system as set forth in claim 1, which utilizes broadband radiating elements to minimize antenna group delay and has symmetric and wideband antennas used in the HZA and MLA antennas to minimize the phase and group delay variation of the antennas as a function of vertical angle, and achieving instantaneous all-band capability by the design and incorporation of broadband elements/components with IMLA techniques and components having demonstrated bandwidths great enough to cover GPS frequencies L5 1176.45, L2 1227.60 and L1 1575.42 without tuning or adjustment.

6. An antenna system as set forth in claim 1, wherein antenna's vertical angle performance is independent of the ground plane under the antenna, using the achieved exactness of MLA array phase and amplitude control at the feed point to each driven dipole; and the optimized syntheses computer program is used to derive the optimum phase/amplitude distribution of absolute control of RF power and phase distribution along the MLA array with very low negative angle RF energy which allows the antenna to be used at any height above ground as well as above any type of reflecting or absorbing surface with insignificant changes to the vertical angle radiation pattern.

7. An antenna system as set forth in claim 1, which provides a very high rate of signal roll-off in the vicinity of the horizon in order to suppress potential jamming signals which are located on the horizon, having a tall, multi-wave length, vertically stacked, dipole array and precise control of the phase/amplitude distribution along the MLA array.

8. An integrated antenna system as set forth in claim 1, providing comparable jamming resistance against terrestrially located jamming transmitters for both the MLA and HZA antennas, having relative signal strength of both the MLA and HZA antennas over their service volumes at approximately the same level above their respective signal levels at the horizon, with jamming resistance being optimized by signal level drop-off between +5 degrees and 0 degrees for said MLA antenna being approximately 23 dB, whereas the signal level drop-off between +35 degrees and 0 degrees for the HZA antenna is 22 dB, so that when combined the IMLA provides approximately 22-23 dB of jamming resistance against terrestrially located transmitters.

9. An antenna system as set forth in claim 1, wherein the required upper hemispherical coverage volume is divided into two or more sections to optimize the antenna system's desired to undesired (D/U) radiation pattern ratio by shaping and/or spacing the antenna beams for optimum performance while highly suppressing the sidelobe levels over a limited range of negative below the horizon angles rather than over the entire negative angle region, said “selective sidelobe level suppression” allowing significant performance enhancement over an approach which requires “complete negative angle sidelobe suppression,” said optimized multi-beam pattern shaping also allowing optimization of the critical low elevation angle gain patterns, while simultaneously providing excellent pattern slope and sidelobe levels, accomplished through precise control of phase and amplitude to active elements and design of beam-shaping components in addition to optimizing the close proximity locations of both antennas.

10. An antenna system as set forth in claim 1, where solid, conducting, lightning air terminals have minimal effect on the performance of the antennas and wherein the HZA antenna pattern only covers the service volume above 30 degrees in elevation angle, providing an antenna system which provides the required 45 degrees cone of protection for the entire antenna system, and wherein MLA's radiation pattern is also well suppressed when looking in the direction of the air terminals, in that the air terminals are located at a vertical angle of approximately +85 degrees relative to the MLA, and lightning protection is provided with minimal RF pattern degradation even though the antenna system provides hemispherical coverage.

11. An antenna system as set forth in claim 10 having both MLA and HZA antennas with obstruction lighting structurally mounted to the antenna system and having minimal effect on the performance of the antenna, in accordance with the description outlined above in claim 10.

12. An antenna system as set forth in claim 1, which utilizes broad-band feed distributions to minimize the resulting group delay of the antenna, having broadband feed distribution and dual radome structure for the MLA antenna and special HZA antenna radome making the IMLA less sensitive to ice/snow and ambient temperature changes, said broad-band design also providing excellent antenna performance over the several, frequency diverse signals used by GPS and other systems.

13. An antenna as set forth in claim 1, including an RF feed network to cylindrical dipole interface which excites the dipole for optimum phase, group delay, and amplitude response, having feed networks with the polarization of the resulting dipole radiator being vertical and very pure, and polarization providing a vertically polarized component of radiation which is approximately 30 dB higher than any horizontally polarized radiated component, with the MLA array utilizing several vertically stacked, co-linear, broad-band, cylindrical, half-wave, dipole elements, each dipole element being fed at 4 locations 90 degrees apart around the circumference of the dipole element for optimum performance, two point feeds, sector feeds and/or spiraled feeds; said methods of dipole excitation producing very pure vertical polarization as well as highly circular azimuth amplitude, phase and group delay patterns.

14. An antenna system as set forth in claim 1, which incorporates a large, hollow, thick wall, multi purpose, metal, center support tube to support said MLA dipoles, the tube structure allowing interfacing cables to be routed inside of the MLA antenna to the HZA antenna and other antennas including obstruction light and equipment located on top of the MLA antenna, and allowing the HZA and MLA to be vertically co-linear (coaxial/concentric) in application, so that spurious RF is not allowed to escape from inside the tube and degrade antenna performance, and interfacing cables located inside the support tube of the MLA antenna do not degrade or affect the pattern performance of the MLA or other antennas located above the MLA, said hollow center support tube houses the RF feed network of the MLA antenna, so that MLA's feed network, although large and complex, does not interfere with the radiation performance of the MLA, and thick wall hollow center support tube of the MLA is also used as down conductor for lightning protection of the antenna structure, with use of a metal tube for this function producing a Faraday shield around the MLA's feed network and interface cables to significantly decrease the antenna's lightning susceptibility by shielding the complex feed network from high induced voltages caused by large lightning currents around the center support tube, inside RF cables and coaxial lines are shielded/grounded at several points inside of the support tube to minimize any possible cross-talk between dipole feed lines.

15. An antenna system as set forth in claim 1, which implements a DC grounded dipole feed to produce balanced cylindrical dipole excitation at multiple locations around the dipole and provides immunity to lightning and atmospheric discharge, achieved by carefully selecting the number of feeds used around each cylindrical dipole driven by the required phase and group delay variation of the azimuth pattern of the antenna, wherein the greater the number of feed points around the open perimeter of the dipole the less phase and group delay variation of the radiating element in the azimuth plane, and wherein the shield of the coaxial line extending to each of the dipole elements is grounded by a conductive feed-through element which produces an RF ground point at the midpoint between the two cylindrical dipole arms, the center conductor of the coaxial feed line is connected to the open end of the top dipole arm at multiple points, both the grounded and feed sides of the dipole see very high impedance as they look down the center support tube while seeing only typical dipole radiation resistance on the surfaces of the cylindrical dipoles and the open end of the grounded cylindrical dipole cup serving as an effective balun which balances the coaxial TEM mode energy to the dipole, thereby reducing lightning susceptibility.

16. An antenna system as set forth in claim 1, which utilizes vertical polarization to optimize the multipath rejection capability of the array and receive and transmit GPS signals which are typically otherwise RHCP having vertical polarization which allows enhanced sidelobe, D/U, gain and pattern control as compared to RHCP, and use of vertical polarization providing improved multipath rejection due to the ground reflection coefficient going to zero at Brewster's angle and reverses phase.

17. An antenna system as set forth in claim 1, which utilizes concentric coaxial radome structures to provide significant improvement in strength, de-icing capability, pattern distortion, and minimized deflection in wind loading wherein said system has a multiplicity of concentric cylindrical radomes having air gaps between radomes and which are rigidly bonded at both ends; said coaxial radome design allowing the implementation of a radome heating mechanism which passes heated air between the radome structure to heat and de-ice the radome surface, and the large air space provided between the MLA radiating array and the outer radome also providing greater immunity against antenna pattern distortion due to ice/snow buildup on the radome.

18. An antenna system as set forth in claim 1, which provides high pattern stability as a function of frequency and is not sensitive to manufacturing process errors, wherein said system has specific pattern synthesis and phase amplitude tolerance control to minimize amplitude, phase and group delay pattern variations.

19. An antenna system as set forth in claim 1, which provides wide temperature stability in its amplitude, phase and group delay patterns, said system having the application of nearly equal feed line lengths using phase stabilized coaxial cable.

20. An antenna system as set forth in claim 1, having MLA feed network with associated phase/amplitude distribution that when combined with the cylindrical dipole array provides a D/U ratio over its service volume of 30 to 40 dB having specific, optimized MLA phase amplitude distribution with minimized phase amplitude errors.

21. An antenna system as set forth in claim 1, which provides a repeatable, known, phase variation as a function of vertical angle having the achieved exactness of MLA phase and amplitude control at the feed point to each dipole and the optimized phase/amplitude distribution across the array.

22. An antenna system as set forth in claim 1, which provides nearly zero phase and group delay variation over its service volume and can be used as a high accuracy survey antenna having a broadband cross-V-dipole and broadband beam forming elements.

23. An antenna system as set forth in claim 1, which utilizes a highly symmetric cross-V-dipole to achieve minimum phase and group delay by having specific balun and dipole element geometry and length control as well as large diameter radiators.

24. An antenna system as set forth in claim 1, which implements a multiplicity of techniques to achieve high D/U ratio, S/N ratio, low sidelobe levels and gain flatness in its coverage area which has in combination:
a) a flat, conductive, counterpoise oriented orthogonal to the vertical axis of the antenna;
b) a shaped concave reflector and associated counterpoise electrically connected to a second conductive counterpoise which electrically and mechanically connects the cross-V-dipole to the beam forming network;
c) a vertically oriented, quarter wave, RF choke which suppresses the surface wave traveling along the surface of the microwave absorbing material;
d) a precisely shaped piece of RF absorbing material with specific carbon fill factor having a shaped inside surface to control the positive angle radiation pattern and whose shaped outside surface helps control the broadside and negative angle portions of the radiation pattern;
e) a highly symmetric cross-V-dipole having RHCP output polarization which produces a symmetry and ellipticity ratio over the service volume; and
f)a specifically defined geometry between each mutually interactive element of the HZA antenna.

25. An antenna system as set forth in claim 1, which resists the accumulation and buildup of snow and ice and prevents water intrusion and deters birds from landing on top of the antenna, having a radome structure without any protruding fasteners or other protruding features that would retain snow/ice buildup and which would not allow water intrusion due to the extruding radome flange extending below the mounting plate and having an “anti-bird” spike to deter birds from perching atop the radome.
